(19) United States
(12) Patent Application Publication
(10) Pub. No.: US 2004/0040024 A1
(43) Pub. Date: Feb. 26, 2004

(54) System and method for a process shutdown interface

(76) Inventors: Brett Green, Meridian, ID (US); Daniel Travis Lay, Meridian, ID (US); Curtis Reese, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/227,371

(22) Filed: Aug. 23, 2002

(51) Int. Cl. G06F 9/00

(52) U.S. Cl. 718/100; 719/320; 719/328

(57) ABSTRACT

A method is provided for terminating a process based on a user request and enabling process shutdown where possible. The method includes the step of sending a process termination request through an operating system. A further step is receiving the process termination request in a shutdown interface that is operable in the operating system. Another step is issuing a shutdown request from the shutdown interface to allow the process to initiate a shutdown of functions, which are able to respond to the shutdown request. Yet another step is issuing a subsequent termination message from the shutdown interface to terminate the process after any functions to be shutdown have not responded to the shutdown request.

### FIELD OF THE INVENTION

The present invention relates generally to shutting down a computer process.

### BACKGROUND

When a user runs an application or program on a computer, the user is actually requesting the operating system to load and run one or more processes associated with that application. For example, an application can have a primary process that is loaded initially and additional auxiliary processes, which may be loaded as needed.

After applications or processes load, the user expects to be able to constantly and quickly interact with each application whenever they desire. This constant interaction is frequently possible when just a small amount of processing is performed between user events, such as a button click or a menu item request in the application. For example, a word processor performs most of its processing in small parts and the user is able to access the user interface seemingly instantaneously.

Other applications may not be available to the user for a certain period after the user has requested a complex or time-consuming operation. The period may be a few seconds or sometimes longer. Some applications and processes are able to present the user with a screen that notifies a user of the status of their request. Unfortunately, many processes cannot provide this status. This is especially true where the process running on the user's client computer has requested information from a process running on a remote server or database. In these situations, the process will make its request and then appear to freeze as the request is performed remotely from the local machine.

Even when an application presents a screen to the user and tells the user that the application or process is busy performing operations, the user may not know whether the processing request is being processed or whether the application has crashed. This is especially true for an application that is not able to present a user with a progress screen. The user interface in such a situation will appear to be frozen but the application will actually be performing normal processing behind the scenes. Either the user must be patient in this situation or the user can decide to try to terminate the application or process.

To terminate an application's processes, the user opens the operating system's process or task manager and requests that the specific processes terminate immediately. Process termination can also be started by other applications that provide the user an interface to terminate a process by sending termination requests through to the operating system. The ability to terminate an application can be accessed through procedure calls or messages provided by the operating system. The operating system's task manager or equivalent process manager generally has the overriding capability to shutdown a running process within the operating system irrespective of the process' execution status or type.

The operating system can exert this override termination capability regardless of whether the program is a windowed application or an older command line compatible application known as a console application. In the case of Microsoft's Windows™, when the operating system requests a process termination, it appears to make an API call known as TerminateProcess. This call shuts down the running process or application with what is referred to as extreme prejudice. Termination with extreme prejudice is immediate and does not provide the running process with the option to shutdown its currently open resources. For example, the process cannot shutdown memory resources, I/O, files, disk space, peripherals, and similar functions when the process is terminated with extreme prejudice. A termination with extreme prejudice is also available in UNIX and other operating system environments.

If the user decides to terminate a process with extreme prejudice, this can cause problems in many situations because the process is not allowed to shutdown completely when a user termination is initiated. This means that the normal cleanup and shutdown functions cannot be activated. It is especially a problem when a process that is running correctly is unexpectedly terminated by a user, and the process is performing a critical function. Of course, there are legitimate situations where processes should be terminated. For example, a process should be terminated when it has crashed and is no longer executing functions or waiting for dependent processes to complete, or there has been a process or system malfunction.

If a process is still working, then the user generally does not want to terminate the process because at some point the process may complete the task that the user has requested. Terminating a process prematurely can cause serious problems for the process or the entire system. Premature process termination can cause corruption in the process itself and cause corruption to other processes or services from which the original process has requested information. One situation where this might happen is a process that is requesting information from or trying to write to a database. If the process is writing the information to the database and then the process is prematurely terminated, the database may be corrupted and/or left in a partially completed state.

### SUMMARY OF THE INVENTION

The invention provides a method for terminating a process based on a user request and enabling process shutdown where possible. The method includes the step of sending a process termination request through an operating system. A further step is receiving the process termination request in a shutdown interface that is operable in the operating system. Another step is issuing a shutdown request from the shutdown interface to allow the process to initiate a shutdown of functions, which are able to respond to the shutdown request. Yet another step is issuing a subsequent termination message from the shutdown interface to terminate the process after any functions to be shutdown have not responded to the shutdown request.

### BRIEF DESCRIPTION OF THE DRAWINGS

FIG. 1 is a block diagram of a system for shutting down processes in accordance with an embodiment of the present invention;

FIG. 2 is a block diagram of a system for shutting down a process where a handle is available to the application's resources and processes in an embodiment of the invention;

FIG. 3 is a block diagram illustrating a system for shutting down processes where a command flag is used; and

FIG. 4 is a flowchart of steps used in an embodiment of a method for shutting down processes.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

As discussed above, the operating system has the overriding capability to terminate a running process or application regardless of whether the process is currently running or the process has crashed. An immediate termination with extreme prejudice can be used with both graphical interface type applications and older console type applications that are character based. A termination with extreme prejudice means that a running process or application can be terminated even if its outstanding functions or child processes have not completed processing. This immediate termination of a process with no option for the executing process or functions to shutdown their currently opened resources or save data can create the problems of corrupted information and/or lost data.

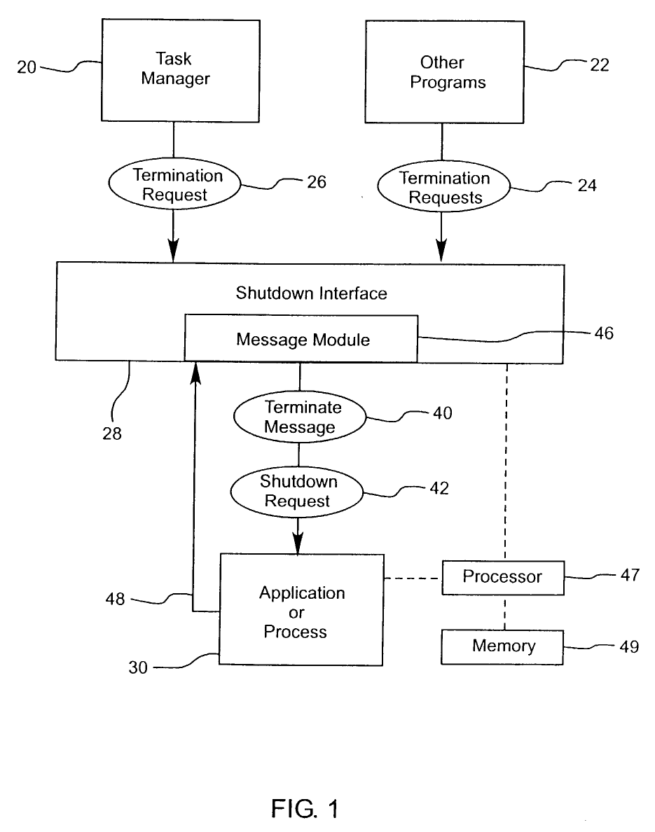

The present invention includes a system and method for terminating a process based on a user request or a request from a task manager in an operating system and enabling the process to shutdown any outstanding functions or processes when possible. FIG. 1 illustrates a task manager 20 that can issue an immediate process termination request 26 with extreme prejudice. This termination request is sent through the operating system and is destined for an application 30 that has a message queue, at least one running process, and possibly other child processes. Other programs 22 besides the task manager can send termination requests 24 through the operating system. Any termination message that is sent with extreme prejudice will be intercepted by a shutdown interface 28. The shutdown interface is configured to capture or intercept the process termination requests from the task manager or program as it is transmitted through the operating system. When the shutdown interface receives the process termination request, it can identify and then hold the termination request.

Once the shutdown interface 28 has received a process termination request 24, 26 the shutdown interface will issue a shutdown request 42 to allow the application or process 30 to initiate the shutdown of functions that are able to respond to the shutdown request. This shutdown request or close message will be received by the process(es) or application before any further messages are sent to the application. Some processes may not be able to respond to the shutdown request or close properly if the processes have crashed. The expression “termination” in this discussion refers generally to the termination of a process or program without the opportunity to complete the intended processing before a shutdown. On the other hand, the use of the expression “shutdown” herein refers to the situation where the process is able to complete its intended processing before termination, when possible.

The shutdown interface 28 can optionally send the shutdown request from a message module 46 in the shutdown interface. The message module can be configured to receive the termination requests from the shutdown interface and issue a shutdown request or close message to the process or application. Following the shutdown request, the message module or shutdown interface can send a subsequent termination message to terminate the process or application after any functions to be shutdown have not responded to the shutdown request.

The message module can also be used to determine whether functions to be shutdown have responded to the shutdown request in a number of ways. The shutdown request or close message 42 can be either an active shutdown request or a passive shutdown request. A passive shutdown request will send a shutdown request to the process and then the termination message will be sent to the process within a set amount of time. The set amount of time can be predetermined by the shutdown interface, operating system or it can be dependent on the type of process that is being shutdown (e.g., user application, system service, remote procedure, etc.).

An active shutdown request sends a shutdown request to the process and requests that a confirmation message 48 be sent back to the message module 46 to confirm whether the processes or functions are able to shutdown. When the processes are completely finished, they can send a finished message to the message module. At this point, a termination message can be sent and any processes or functions that were not able to shutdown will be forced to shutdown. If the process does not send back a confirmation message, then it can be immediately terminated.

In the past, operating systems have not included a shutdown interface because termination requests were typically made by users or administrators who were very knowledgeable about the computer system. As computer systems have become more widely used and more available, not all users are aware of the problems associated with suddenly terminating an operating process. Sometimes a user may see a process or service that they mistakenly believe should be terminated, but the termination of the process can create problems in the operating system such as data corruption or overall system instability. In addition, the user may terminate a service that is used by other processes, which may halt the dependent processes.

Providing a shutdown interface allows the operating system to intercept the termination requests that have extreme prejudice and to aid the process or application, for which the termination request is intended, to shutdown normally. In other words, the shutdown interface allows the outstanding processes or functions to run to their normal completion or intended finish states if possible even though a termination with extreme prejudice has been requested. This allows the processes and functions to close files, save data, release resources, and complete functions as intended. When processes terminate normally and data processing functions are completed, corruption and data loss are avoided.

One possible way to implement a shutdown interface is to supply an application program interface (API) that is designed to receive process termination requests with extreme prejudice. This means that when the termination requests are sent by a process executing in the operating system, they can automatically be intercepted by the API that is designed to intercept those termination requests. The shutdown interface may also be set up as a “wrapper” that insulates any previously existing termination interface in the operating system from the direct termination requests. The application or process 30 and shutdown interface 28 with the message module 46 can be running on a processor 47 and stored in a memory 49 or mass storage medium (FIG. 1).

One advantage of the shutdown interface is that it delays the process termination request received by the shutdown interface. This is valuable where the main portion of an application or process may have crashed while part of the program is still functioning. This allows the viable processes, functions or threads to be shutdown properly while the defunct portion is subsequently and efficiently terminated.

A further advantage of the present system is it provides system protection when an unsophisticated user terminates processes or applications from the task manager, despite the fact that these programs have not crashed. In these situations, it is valuable to be able to let the processes, applications or threads run to completion. This present system allows the functions and processes to clear out their buffers, save data, and perform other needed processing, so that the information and files associated with those processes are not corrupted or lost.

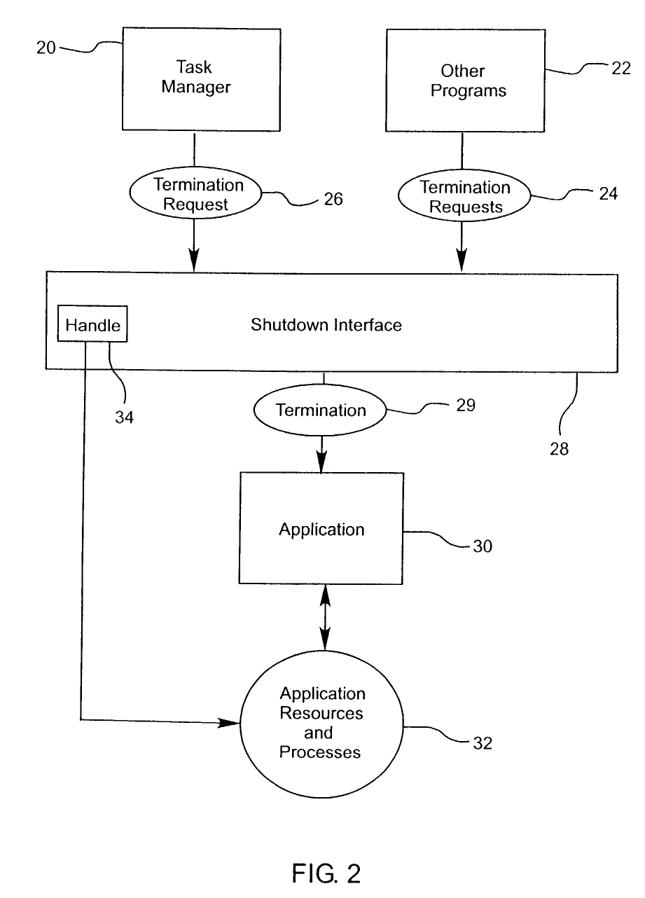

An additional embodiment of a system and method for allowing processes to completely shutdown is illustrated in FIG. 2. A task manager 20 or other programs 22 can send termination requests 24, 26 to the shutdown interface 28. When the shutdown interface receives the termination request(s), it will make a request to the operating system to retrieve handles 34 for the application resources, child processes and/or threads 32 that are registered in the operating system. Essentially, this enumerates all of the running processes with specific identification data, values or handles. For example, using the EnumProcesses call in the Microsoft Windows environment will return the handles.

Each of the processes, functions or resources for which the system has a handle, are sent a shutdown request from the shutdown interface. This allows each of the processes to run to completion or gracefully shutdown before the process(es) or application is terminated. Using a handle to each of the processes allows the shutdown interface to attempt to shutdown and clean up each of the processes and/or resources individually. Even if the application has crashed and cannot make a shutdown request to the processes or release application resources, the shutdown interface will be able to try and gracefully shutdown the remaining processes and resources. After each process has been allowed the opportunity to shutdown appropriately, then a delayed termination request 29 is sent to the application and the application is forced to shutdown. A termination request can also be sent through the process handles for those processes that have not shutdown properly, if needed.

Using a handle or process ID to shutdown the processes is useful from a system resource point of view. Since each process registers its ID with the operating system, this means that processes are generally unable to escape the shutdown process, even if the application itself crashes. In addition, the shutdown interface can determine if a given process has released its resources back to the operating system. The shutdown interface can force the process to release the resources just as the operating system would when the process is not able to release a resource. The shutdown interface knows which application is being terminated and can identify its resources and process IDs. Examples of resources that can be identified by the shutdown interfaces are memory, disk space, peripheral use and other similar input and output functions.

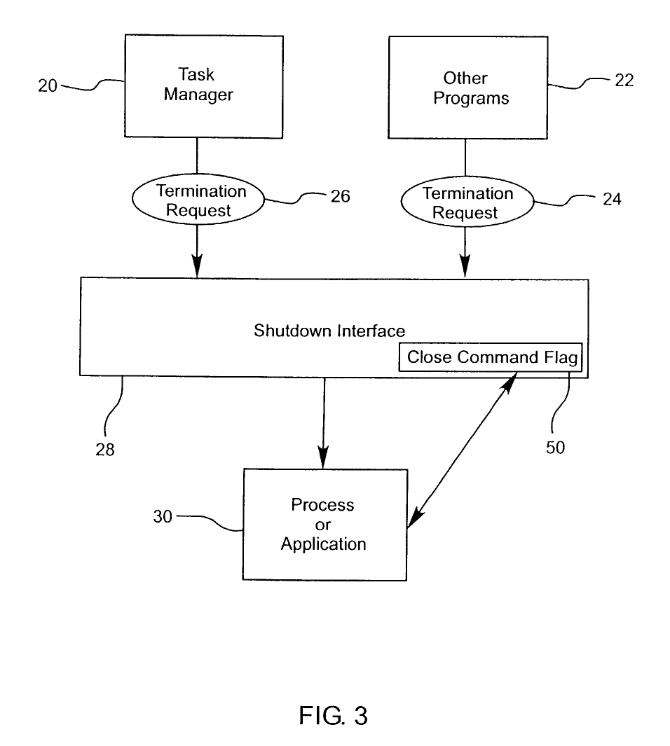

FIG. 3 illustrates a system and method for terminating a console process 30 based on a user termination request 24, 26 from a task manager 20 or other programs 22, while enabling a complete process shutdown where possible. Initially, a close command flag 50 will be set for the console process within the operating system. This close command flag can be initialized within the operating system when the console window is established. Then the close command flag is repeatedly read by the application or process running in the console window 30 to determine when the operating system has set the flag for closure. This flag will be set by the task manager 20 or some other program when a termination request is sent to the shutdown interface 28.

After the close command flag 50 has been set, then the application 30 can identify that the flag state indicates that the console process should close. In other words, the application in the console window can recognize this close flag and shutdown by completing the functions that it needs to close gracefully.

In current operating systems, an application running in the console window will be immediately terminated with no opportunity for a proper shutdown when a termination request is sent for the console process. The shutdown interface of the present invention allows the console process to recognize that the immediate termination flag has been set and to shut itself down appropriately. Once the application has been shutdown properly, then it can terminate itself or accept the terminate request from the shutdown interface. A shutdown of any outstanding functions that are able to respond to a shutdown request allows the system to avoid leaving parts of the application in an unknown state. For example, the present invention avoids leaving memory, open files, or unread input and output in an unknown state, which can corrupt the application and/or data that is used and stored by the application.

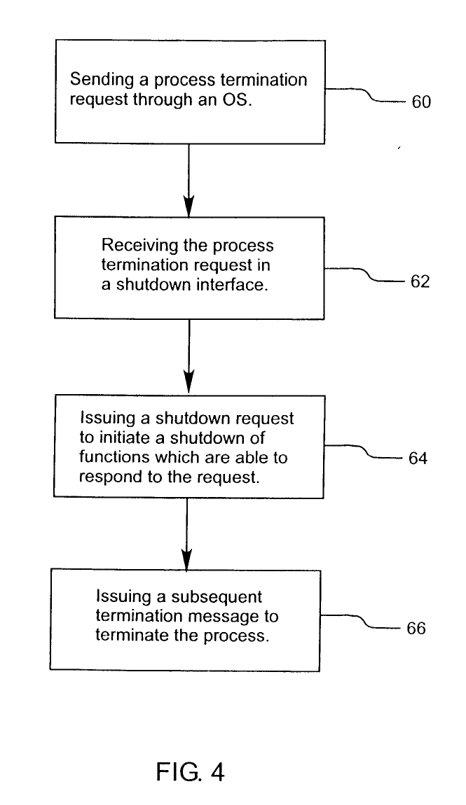

The present invention provides a method for terminating a process based on a user request and enabling process shutdown where possible, as illustrated in FIG. 4. The method includes the operation of sending a process termination request through an operating system in block 60. A further operation is receiving the process termination request in a shutdown interface that operates within the operating system in block 62. Another operation is issuing a shutdown request from the shutdown interface to allow the process to initiate a shutdown of functions which are able to respond to the shutdown request in block 64. A subsequent termination message is issued from the shutdown interface to terminate the process after any functions to be shutdown have not responded to the shutdown request in block 66. In order to determine whether the functions have not responded to the shutdown request, a timer may be used to determine that the termination message can be sent. Alternatively, the shutdown interface may recognize that no reply message has been received from the process or functions being shutdown. An optional step is delaying the communication of the process termination requests to the specific process.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and exemplary embodiment(s) of the invention, it will be apparent to those of ordinary skill in the art that numerous modifications can be made without departing from the principles and concepts of the invention as set forth in the claims.

What is claimed is:

1. A method for terminating a process based on a user request and enabling process shutdown where possible, comprising the steps of:
sending a process termination request through an operating system;
receiving the process termination request in a shutdown interface that is operable in the operating system;
issuing a shutdown request from the shutdown interface to allow the process to initiate a shutdown of functions which are able to respond to the shutdown request; and
issuing a subsequent termination message from the shutdown interface to terminate the process after any functions to be shutdown have not responded to the shutdown request.

2. A method as in claim 1, wherein the step of sending a process termination request further comprises the step of sending a process termination request through the operating system from a task manager.

3. A method as in claim 1, wherein the step of sending a process termination request further comprises the step of sending a process termination request through an operating system from a program executing in the operating system.

4. A method as in claim 1, further comprising the step of implementing the shutdown interface as an application program interface (API) designed to receive process termination requests that have extreme prejudice.

5. A method as in claim 1, further comprising the step of delaying the process termination request that is received in the shutdown interface.

6. A method as in claim 1, further comprising the step of notifying the process that the shutdown interface will wait a predetermined amount of time for a response before issuing the subsequent termination message.

7. A method for terminating a selected process based on a user request from a task manager and enabling process shutdown, comprising the steps of:
sending a process termination request from the task manager for the selected process;
receiving the process termination request in a shutdown interface that is operable in the operating system;
determining that the process termination request has been received;
delaying the communication of the process termination request to the selected process;
issuing a shutdown command to the selected process in order to initiate a shutdown of functions which are able to respond to the shutdown command; and
issuing a subsequent terminate command to terminate the process after any function which can be shutdown has responded to the shutdown command.

8. A method as in claim 7, wherein the step of receiving the process termination request in a shutdown interface further comprises the step of receiving the process termination request in a shutdown interface that is an application program interface (API) designed to receive the process termination requests.

9. A method as in claim 8, further comprising the step of issuing a terminate command to terminate the process regardless of remaining resources that were not able to be shutdown.

10. A method as in claim 7, further comprising the steps of:
accessing a handle to active application functions; and
activating the active application functions from the shutdown interface through the handle in order to shut down the active application functions.

11. A method as in claim 7, further comprising the steps of:
accessing a handle to active application processes; and
communicating with the active application processes from the shutdown interface through the handle in order to shut down the active application processes.

12. A method as in claim 7, further comprising the step of notifying the process that the shutdown interface will wait a predetermined amount of time for a response before issuing the subsequent termination message.

13. A method for terminating a console process based on a user request from a task manager and enabling normal process shutdown, comprising the steps of:
setting a close command flag for the console process within an operating system;
reading the close command flag repeatedly;
identifying when the close command flag has been set for console process closure;
closing the console process when the close command flag is set by allowing the process to shutdown any outstanding functions that are able to respond to a shutdown request; and
terminating the console process.

14. A method as in claim 13, wherein the step of closing the console process further comprises the step of closing the console process by shutting down currently open resources.

15. A method as in claim 14, wherein the step of closing the console process further comprises the step of closing the console process by shutting down currently open resources selected from the group of resources consisting of memory resources, I/O resources, disk resources, peripheral resources and open file resources.

16. A method as in claim 13, further comprising the step of issuing a termination command to terminate the process regardless of remaining resources that were not able to be closed.

17. A system for terminating a process when an immediate process termination request is issued by an operating system, comprising:
an application with a message queue and at least one process; and
a shutdown interface configured to capture a process termination request from a user controlled process running in the operating system;
a message module in the shutdown interface, configured to receive the process termination request from the shutdown interface and issue a close message to the application followed by a termination message.

18. A device as in claim 17, wherein the message module is configured to receive messages from the application as to the state of the close message.

19. A device as in claim 17, wherein the message module can issue further close commands to additional processes which need to be shutdown.

20. A device as in claim 17, wherein the message module can issue further close commands to additional process threads which need to be shutdown.

21. An article of manufacture, comprising:
a computer usable medium having computer readable program code embodied therein for terminating a process based on a user request and enabling process shutdown where possible, the computer readable program code means in the article of manufacture comprising:
computer readable program code for sending a process termination request through an operating system;
computer readable program code for receiving the process termination request in a shutdown interface that is operable in the operating system;
computer readable program code for issuing a shutdown request from the shutdown interface to allow the process to initiate a shutdown of functions which are able to respond to the shutdown request; and
computer readable program code for issuing a subsequent termination message from the shutdown interface to terminate the process after any functions to be shutdown have not responded to the shutdown request.

22. An article as in claim 21, wherein the computer readable program code in the article of manufacture further comprises computer readable program code means for providing a shutdown interface that is an application program interface (API) designed to receive process termination requests that have extreme prejudice.

23. A system for terminating a process when an immediate process termination request is issued by an operating system, comprising:
an application with a message queue and at least one process;
a shutdown interface means for capturing a process termination request from a user controlled process running in the operating system; and
a message module means in the shutdown interface, for receiving the process termination request from the shutdown interface and for issuing a close message to the application followed by a termination message.
